(19) United States
(12) Patent Application Publication
(10) Pub. No.: US 2007/0267986 A1
(43) Pub. Date: Nov. 22, 2007

(54) Multiple Control Device for Electric Motors

(75) Inventor: Francis Delaporte, Osny (FR)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 10/571,378

(22) PCT Filed: Sep. 9, 2004
(86) PCT No.: PCT/FR04/02284

§ 371 Date: Feb. 28, 2007

(30) Foreign Application Priority Data
Sep. 11, 2003 (FR) 0310703

(51) Int. Cl. H02P 1/54

(52) U.S. Cl. 318/103

(57) ABSTRACT

The system relates to electric motors for operating accessories in a motor vehicle for combining the commands of several electric motors. Each combination comprises electric power supply means, relays for controlling the motors and means for controlling the relays. Switch means are provided for cutting off the power supply to the motors and the control means are designed to open or close the switch means only when a predetermined state is reached.

### CROSS REFERENCE TO RELATED APPLICATIONS

The present Application claims the benefit of priority to the following International Application: PCT Patent Application No. PCT/FR2004/002284 titled “System for the Multiple Control of Electric Motors” filed on Sep. 9, 2004 (which is incorporated by reference in its entirety).

### BACKGROUND

The present application relates to the area of the multiple control of electric motors fitted to motor vehicles, particularly those used in the function known as central door locking whereby the locking and unlocking of the doors is controlled centrally. However, many other motors can also be considered, such as those of the seats, the mirrors, the flaps of the air-conditioning system, the fuel flap, the sunroof, the windows, etc.

The expression “system for the multiple control of motors” is used here to refer to a system designed to combine the commands of several electric motors in different combinations corresponding to different states of the function in question, such as partial or total locking/unlocking corresponding to the “lock”, “superlock” and “rear superlock” (child protection) states of the door locking function referred to above.

These motors are controlled by relays which in turn are operated by a microprocessor providing central coordination of the commands given by the user.

A recent technological advance particularly in so-called passive entry technology now allows the use of motors with significantly faster response times, typically a few milliseconds or tens of milliseconds, whereas response times used to be more than one hundred milliseconds, if not hundreds of milliseconds.

When considering the passive entry function, which allows the door to be opened when its handle is operated because of a badge worn by the user, the slightest wait is no longer acceptable.

Since these motors have speed of response characteristics close to those of the relays which control them, there is a problem with their multiple-control use in that their commands have to be synchronized more accurately if the system is to avoid transitional combinations which could create a functional state not desired by the user. In other words, and more practically, there is a risk that a car door may be unlocked without the user being aware of the fact.

The likelihood of these unwanted transitional combinations occurring is increased by the fact that the boxes of relays, sensors and motors provided for the function in question may come from different manufacturers, and may have disparate characteristics.

Answers to this problem have already been proposed, such as those described in document EP 0 924 372. These consist in introducing delays to each of the commands applied to the motors but this is deliberately to undo what is a valuable advance from the point of view of the vehicle user.

The applicant has aimed to make the best possible use of the speed characteristics of the new motors, while avoiding constraints in the choice of the manufacturers of the electronic boxes and sensors, as this would be industrially costly.

### SUMMARY

One embodiment of the invention relates to a system for the multiple control of electric motors for operating accessories in a motor vehicle for combining the commands of several electric motors, each combination corresponding to a predetermined function state, wherein the system includes electric power supply means, relays for controlling the said motors, controlled by cutting off their power supply, and means for controlling the said relays, the said system being characterized in that it comprises switch means for cutting off the power supply to the said motors and the control means are designed to open or close the said switch means only when a predetermined state is reached.

### BRIEF DESCRIPTION OF THE DRAWINGS

A clearer understanding of the present application will be made possible by the following description of an exemplary embodiment of the system for the multiple control of electric motors according to the invention, with reference to the appended drawings in which:

FIG. 1 is a functional circuit diagram of the multiple-control system according to the invention; and

FIG. 2 is a timing diagram of an example of combined commands issued by the control means of the multiple-control system according to the invention.

### DETAILED DESCRIPTION

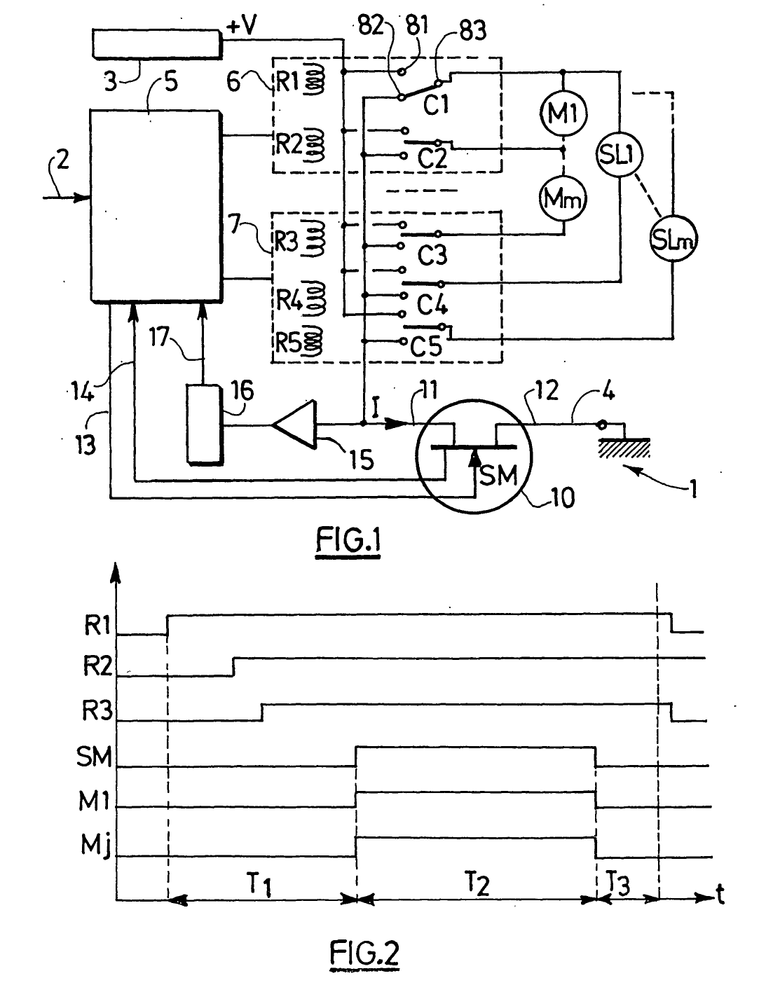

Referring to FIG. 1, the system 1 for the multiple control of electric motors performing a function comprises, in addition to motors M1 to Mn and SL1 to SLm which are to be operated in combination, a controlling microprocessor 5 which, on the basis of instructions 2 from a user, opens or closes the contacts C1, C2, C3, C4, Ci, . . . , and the corresponding relays R1, R2, R3, R4, Ri, . . . .

In the example shown in FIG. 1, R1, C1, and R2, C2 are all in one relay box 6, and R3, C3, R4, C4, R5, C5 in another relay box 7. Only two boxes have been shown but there may of course be more than this number.

A motor is controlled by two contacts. For example motor M1 is controlled by the two contacts of box 6. However, any given motor Mj (j being from 1 to n) or a motor SLk (k being from 1 to m) can be controlled by two relays Ri and Ri+1 from boxes from different manufacturers, like the motors Mn or SL1, which are connected, in the figure, to two boxes 6 and 7.

All the contacts Ci have two positions 81 and 82, either of whose terminals can be connected to a terminal 83 of a motor Mj or SLk. Terminal 83 is connected in position 81 to a supply 3 which is common to the motors of the function, and in position 82 to the supply return for the same motors. Here, this return is the reference potential, in the present case the ground 4 of the system 1.

The structure thus defined makes it possible to connect the two terminals of a motor either to supply it with a positive or negative current I, or not to supply it therewith, in which case both terminals are connected to the same polarity, the supply 3 or ground 4.

The microprocessor 5 is designed to control in combination the relays Ri, and hence the motors Mj or SLk, in view of the function to be performed, taking this structure into account in such a way as to avoid any inconsistency, notably inconsistencies leading to short-circuits or to undesired states of the function, and corresponding to temporary command combinations resulting from the fact that, for example, the boxes are from different manufacturers and that the motors are faster.

For example, to close the driver's door of a vehicle, only motor M1 will be operated, while the other motors Mn or SL will be excluded. To lock the rear doors, two motors M3 and M4 could be operated, or the “rear superlock” motor SL2 could be operated alone; but it is also possible, in this state of the function, to also lock the front passenger door through the motor M2. General locking will operate four motors M1 to M4, or the two motors SL1 and SL2, etc.

Here, all terminals 82 of contacts Ci are connected to terminal 11 of a JFET or MOSFET “smart power” transistor 10, also designated by the letters SM, which furthermore is connected to the ground 4 of the system 1. The transistor SM is controlled by an output 13 of the microprocessor 5 and sends it an “operating temperature correct” signal, as ordinarily delivered by “smart power” transistors, via a link 14. These transistors work in two states: an off state and an on state. The off state allows the motor supply to be put in the rest mode.

The current I passing through the transistor SM is read on its terminal 11 and amplified by an operational amplifier 15 whose output is connected to an analogue-digital converter 16 which provides in real time the digital value of the current I to the microprocessor 5 via a link 17.

The microprocessor 5 can thus control a motor Mj or SLk of its choice and collect the value of the resulting current I to compare it with a reference Gj defining correct operation of the motor, chosen according to signal processing methods known to those skilled in the art.

Referring to FIG. 2, when the user requests the function performed by the system 1, with a particular instruction designed to place the function in a particular state Ep, the instruction is transmitted to the microprocessor 5 by the link 2. To place the function in the state Ep, the microprocessor determines, by considering the desired state Ep and the preceding state Ep−1, what combination of motors Mj and/or SLk should be supplied with electric current I and from this works out which relays Ri to operate, as in the normal way.

For example, in FIG. 2, where the motors to be supplied are motors M1 and Mn, the relays to be operated are relays R1, R2, and R3. The microprocessor 5 operates them and the contacts Ci switch to positions 81 or 82 depending on which combination is required.

As the transistor SM is not operated, it is in an off state, no current I flows through the motors and no unwanted state can occur while the contacts Ci with the relays Ri are switching.

After a sufficient period of time T1 allowing all the relays in question R1, R2, R3 to switch, the microprocessor 5 operates the transistor SM via the link 13, turning it on and causing current to flow. The motors M1 and M2 are now connected to the supply 3 on one side and to ground 4 on the other, which causes the current I to flow through them.

After a second period of time T2 sufficient for the motors M1, M2 to reach the end of their travel, the desired state Ep is reached and the microprocessor stops the operation of the transistor SM.

Depending on the particular state Ep that has been reached, it is possible that the next state Ep+1, desired by the user, is naturally known or predictable, or even merely the most likely state. The microprocessor can anticipate this state Ep+1 by pre-positioning the relays Ri after a sufficient period of time T3 to allow the transistor SM to return to the off state. This possible anticipation saves time T1 during the next instruction from the user. This would particularly apply to “passive entry” for the general unlocking of car doors. On leaving the car and locking the doors, the user places the elements presented above in the open position.

If one motor fails, by short-circuiting or any other cause which abnormally increases the electric current I flowing through the motor, the current flowing through the transistor SM increases abnormally and the “smart power” transistor detects an abnormal temperature rise. It reports this to the microprocessor 5 via the link 14, and the microprocessor can output a message or warning or pre-warning signal to the user.

When this happens, during repair work, the repairer can isolate the faulty motor Mj by prompting the microprocessor 5 to operate all the motors of the faulty function in turn, detecting the shape of the signal on the terminal 11 of the transistor SM, this signal being amplified by the amplifier 15, digitized by the converter 16 and transmitted by the link 17, and comparing each signal from each motor with the reference Gj of correct operation of the tested motor.

During this operation, the internal resistance (known as DSR for “drain-source resistance”) of the transistor SM is used as the current I measuring resistance.

1. A system for the multiple control of electric motors for operating accessories in a motor vehicle for combining the commands of several electric motors, each combination corresponding to a predetermined function state, comprising: electric power supply means, relays for controlling the motors, controlled by cutting off their power supply, and means for controlling the relays, the system being characterized in that it comprises switch means for cutting off the power supply to the motors and the control means are designed to open or close the switch means only when a predetermined state is reached.

2. A system according to claim 1, in which the said switch means are connected for cutting off the motor supply return.

3. A system according to either claim 1, in which the control means operate the control relays in accordance with a predicted use before the command is given by the user.

4. A system according to claim 1, in which the switch means comprise at least one electronic switch for cutting off the motor supply return at ground.

5. A system according to claim 4, in which the switch means comprises a MOS transistor designed to deliver information about the operating temperature.

6. A system according to claim 4, in which the switch means comprises a “smart power” transistor designed to deliver information about abnormal operation to the control means.

7. A system according to claim 1, in which means (5, 15, 16) are provided for monitoring the dynamic operation of the motors.

8. A system according to claim 7, in which the means for monitoring the dynamic operation of the motors comprise conversion means for digitizing the electric current I flowing through the internal resistance of the electronic switch transistor.

9. A system according to claim 8, in which the conversion means are designed to provide in real time, to the control means, the values of the electric currents flowing through the motors during their operation.

10. A system according to claim 7, in which the control means are designed to compare the shape of the electric currents flowing through the motors with a reference of correct operation.
